(19) United States
(12) Patent Application Publication
(10) Pub. No.: US 2004/0203351 A1
(43) Pub. Date: Oct. 14, 2004

(54) Bluetooth control device for mobile communication apparatus

(75) Inventors: Edwin H.S. Shearer, Pleasanton, CA (US); Kathryn E. Dienst, San Jose, CA (US)

Correspondence Address: Michael E. Schmitt, c/o Philips Electronics North America Corporation, Corporate Intellectual Property, 580 White Plains Road, Tarrytown, NY, 10591-5190, US

(73) Assignee: KONINKLIJKE PHILIPS ELECTRONICS N.V.

(21) Appl. No.: 10/150,776

(22) Filed: May 15, 2002

(51) Int. Cl. H04B 1/38

(52) U.S. Cl. 455/41.1; 455/557; 455/569.1

(57) ABSTRACT

A device is provided with a Bluetooth module, a control user interface and a headset. The Bluetooth module is configured to receive a downlink wireless Bluetooth signal from a portable Bluetooth-enabled communication apparatus. The wireless Bluetooth signal is representative of data received by the communication apparatus over a wireless network. The control user interface is coupled to the Bluetooth module. The control user interface enables to transmit control commands to the communication apparatus via the Bluetooth module in response to respective user input commands. The headset is mounted on the device and is operably coupled to the Bluetooth module. The headset automatically renders an audio signal to the user when the headset is detached from the device. The audio signal is derived from the downlink wireless Bluetooth signal. The device acts as an ancillary control device to a communication apparatus such as a cell phone, a PDA or a laptop and communications received on the communication apparatus are automatically diverted to the device when the headset is detached from the device

### REFERENCE TO CROSS RELATED APPLICATIONS

Reference is made to copending application, Ser. No. ______, filed May 15, 2002 for “Bluetooth cassette-like device for a hands-free cell phone kit”, for the same assignee and same inventors (attorney docket US020126), herein incorporated by reference.

### FIELD OF THE INVENTION

The invention relates to a Bluetooth device serving as an ancillary device to a wireless communication apparatus. The device may be a portable medallion recreating some basic user interface functionalities of the communication apparatus, e.g. voice input, sound output, volume control, communication channels control and the like.

### BACKGROUND ART

Using a cell-phone or a personal digital assistant may turn out to be very distracting or even dangerous for a user already busy doing something else e.g. driving, walking, biking or running. To solve this issue and reduce the potential risks, the wireless industry has launched several after-market products to free the user from holding the phone while making phone calls. For example, various headsets are manufactured with an earpiece connected to a microphone and most of these headsets or hands-free kits are compatible with any phone brand or model. A possible headset can be plugged-in to the phone and comprise a microphone connected via wires to the headset so that the microphone, when in position, can appropriately capture the voice of the user. Other headsets are built in with a Bluetooth chip so that the voice conversation can be wirelessly diverted from the phone to the earpiece of the headset. The Bluetooth radio chip acts as a connector between the headset and a Bluetooth chip of the cell-phone. When the phone rings, the user can answer by simply pressing a key on the headset. Likewise, if the user wants to make a call, he may press a key on the headset and use voice recognition to initiate the call. The headset may also have a volume control to adjust the volume level of the earpiece. In addition to diverting the audio, these headsets often also permit to partially control the cell-phone or the communication apparatus associated with it.

For example, the headset may comprise a voice command software application so that the user may remotely control his cell-phone by voicing the commands in a microphone of a control module. Such a wireless, voice-activated system to control an electronic device is disclosed in U.S. Pat. No. 6,339,706, incorporated herein by reference. The remote control device permits to transmit control commands to the electronic device, which is possibly a phone, PDA or laptop over a wireless link being e.g. a Bluetooth link.

U.S. patent application Publication US 2002/0021800, herein incorporated by reference, proposes a communication unit with a housing in which a transducer is placed and a microphone arm is suspended. The communication unit may be Bluetooth-enabled. The proposed communication unit permits to power up the communications links with another Bluetooth device such as a cellular phone handset. Software may be provided to detect this “on” detection and wake up the cell phone and establish a link under the Bluetooth or other linking signal. Furthermore, it is possible for the headset, via this detection system, for the headset to inform another Bluetooth device, like a cell phone to go “off-hook” and redirect voice signals thru the headset instead of using the microphone/speaker of the cell phone. The user can merely open the microphone arm to answer a call without touching the cell phone at all.

So far Bluetooth has been seen as the best candidate LAN technology to permit to delegate the control of a communication apparatus. A Bluetooth special interest group was formed to define and promote the Bluetooth technology. This group consists of employees of companies involved in Bluetooth who define together some of the technical requirements for Bluetooth products to ensure interoperability among products. Reference is made to one of the specification being drafted and reviewed by the Bluetooth SIG (Special Interest Group) Car Profile Working Group, “Hands-Free Profile”, Oct. 22, 2002 by Jesus A G. Pulido, herein incorporated by reference. This draft seeks to define the protocols and procedures that shall be used by devices implementing the usage model of operating a phone via an in-car device. This working group is interested in all implementations of the hands-free profile that enable a car's embedded hands-free unit to be wirelessly connected to a cellular phone for the purposes of acting as the cellular phone's audio input and output mechanism, providing full duplex audio with possibly noise suppression, voice recognition and so on.

However other data communication technologies have been considered and may also enable to divert the control of performance of tasks from one device to another. For example, infra-red communication has also been contemplated. The international publication WO 02/19669 discloses a hands-free kit for a mobile radio-telephone handset comprising an earpiece and an infrared transmitter. The transmitter is arranged to relay audio signals from the handset to the earpiece signals from the transmitter. Thus, by positioning the transmitter in line of sight of the earpiece receiver, audio signals may be relayed from the handset to the earpiece.

### SUMMARY OF THE INVENTION

It is an object of the invention to provide a different headset than the ones proposed by the prior art documents.

It is an object of the invention to enhance the security of the user using a cellular communication device while doing something else.

It is another object of the invention to ease the utilization of a portable cellular communication apparatus.

It is yet an object of the invention to free the user from manipulating a communication apparatus when using it to transmit or receive data.

To this end, a device of the invention comprises a Bluetooth module, a control user interface and a headset. The Bluetooth module is configured to receive a downlink wireless Bluetooth signal from a portable Bluetooth-enabled communication apparatus. The wireless Bluetooth signal is representative of data received by the communication apparatus over a wireless network. The control user interface is coupled to the Bluetooth module. The control user interface enables to transmit control commands to the communication apparatus via the Bluetooth module in response to respective user input commands. The headset is mounted on the device and is operably coupled to the Bluetooth module. The headset automatically renders an audio signal to the user when the headset is detached from the device. The audio signal is derived from the downlink wireless Bluetooth signal.

A device of the invention permits to use and communicate data via the communication apparatus without manipulating the apparatus itself. The communication apparatus may be a cell-phone, a PDA, a navigation system, an MP3 player, a pager or the like. The Bluetooth capability of both devices permits to delegate and transfer the use and rendering of some functionalities of the communication apparatus to the device. For example, a voice conversation on a cell-phone is diverted away from the cell-phone and rendered via the headset of the device. To this end, an audio signal representative of the voice conversation is automatically rendered on the headset when the user detaches the headset from the device. As used herein, “detached” indicates that the headset, originally mounted on the device, is now unhooked from the device. However, although detached, the headset may still be connected to the device via a connector conveying the audio signal from the device to the headset. Alternately, the headset may be completely detached and disconnected from the device and in such case, the headset comprises a Bluetooth chip for communicating with the Bluetooth module of the device. The Bluetooth module redirects to the headset the downlink wireless Bluetooth signal received from the apparatus. The device of the invention permits for example, to pick up a phone call received on a Bluetooth-enabled cell-phone by simply detaching the headset mounted on an ancillary device of the invention. The user may also pick up a call by activating a button of the control user interface and the voice conversation is thereafter rendered via the headset when it is detached from the device. When the headset is still mounted, i.e. attached, on the device, the voice conversation may be rendered via a loudspeaker of the device. The user does not need to actuate a button on the cell-phone itself and the user can make or receive calls using the device only. An advantage of the invention is to free the user from manipulating the apparatus when using it to receive or transmit data thereby freeing the user's hands and enhancing the user's security doing something else at the same time. An advantage of the invention is therefore to permit the user to have his hands free to perform other tasks. It must be noted that the device must be in a receiving range of the Bluetooth-enabled apparatus to communicate with the apparatus using the Bluetooth protocol.

As used herein, the data as received by the apparatus over the wireless network encompasses any transfer of data. The data may convey audio data such as speech, music, artificial or natural voice or the data may also convey text data as will be explained hereinafter.

The device may be implemented as a control medallion that can be used anywhere, e.g. when biking on the user's arm or the bike handle; when driving on the car steering wheel; when at work on the side of the computer monitor, etc. A further advantage of the invention is the great convenience the device brings to the user.

The device may also be self-powered with a rechargeable battery that can be recharged either from a solar cell or from a cigarette lighter power source in a car.

### BRIEF DESCRIPTION OF THE DRAWINGS

The invention is explained in further details, by way of examples, and with reference to the accompanying drawing wherein:

FIG. 1 and FIG. 2 show a device of the invention operating with a cell-phone; and,

FIG. 3 is a flowchart illustrating a functioning of a device of the invention.

Elements within the drawing having similar or corresponding features are identified by like reference numerals.

### DETAILED DESCRIPTION

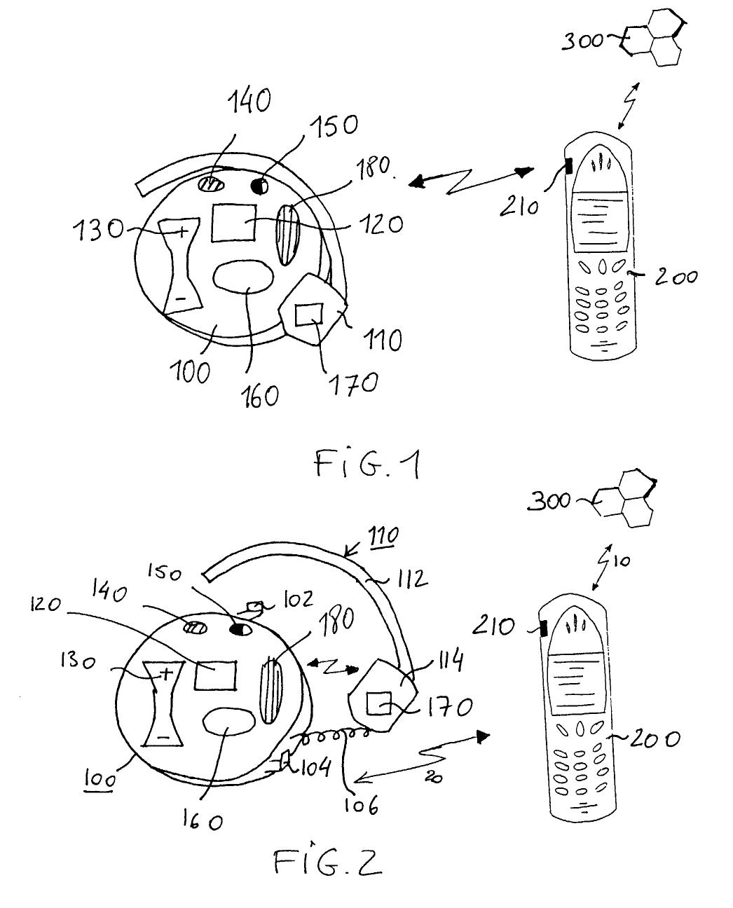

FIG. 1 shows a Bluetooth communication system of the invention. The system comprises an apparatus 200 communicating over a wireless network 300 such as a GSM, CDMA, 3G, UMTS based cellular network or a WLAN network based on e.g. IEEE802.11, HomeRF, Hiperlan2 or the like. The apparatus 200 may communicate text, audio, data or a combination of the like over the wireless network 300. In the embodiment represented here, the apparatus 200 is a cell-phone communicating over a cellular network 300 however the invention is hereby not limited to this implementation and any other type of communication apparatus may also be contemplated, e.g. a pager, a personal digital assistant, a web-pad, a bi-directional remote control, a networked MP3 player, a navigation system or the like. Electronics and software pieces of the cell-phone 200 controlling communications over the cellular network 300 are not shown in FIG. 1. The cell-phone 200 is Bluetooth enabled and in that respect comprises a Bluetooth chip 210 allowing the cell-phone 200 to communicate with another Bluetooth-enabled device located in its receiving range. The protocol for communications between an ancillary device and a Bluetooth cell-phone over a Bluetooth wireless network is described in the Bluetooth specification and in the October 2002 draft “Hands-free” of the Car Profile Working Group Bluetooth SIG.

The system further comprises a device 100 of the invention. The device 100 is a control medallion reproducing some functions of the phone 200 as will be shown hereinafter. The medallion 100 is Bluetooth-enabled, as it comprises a Bluetooth module 120. The medallion 100 further comprises a microphone 140, a loudspeaker 180, a battery level indicator 150, a volume control 130, a call control button 160 and a detachable headset 110. The headset 110 is detachably mounted on the medallion 100.

The Bluetooth module 120 enables the medallion 100 to communicate and transfer data with another identified and authorized Bluetooth device in its receiving range. When the cell-phone 200 is placed in the receiving range of the module 120, the module 120 and the chip 210 identify each other during a probe/quest exchange as defined in the Bluetooth standard. Once the module 120 and the chip 210 are mutually identified, the module 120 is configured to transmit control commands and data signals to the chip 210 and reciprocally the chip 210 may transmit data signals to the module 120. For example, the control button 160 may be coupled to the Bluetooth module 120 so when actuation of the button 160 by the user, the module transmits a control command associated with the actuation to the chip 120. Such control command may permit control of the establishment of a new communication channel with the cell-phone 200 over the cellular network 300 and/or termination of an existing communication channel established with the cell-phone 200 over the cellular network 300. Thus, when the user is notified that a phone call is received or that a request is received for establishing a communication channel with the cell-phone 200 over the network 300, the user may press the button 160 to accept the call. The phone 200 may notify the user visually or audibly by causing text display, vibrating or ringing. Likewise at the end of a call the user may terminate the call by pressing the button 160 or another equivalent button. The module 120 transmits a termination control command to the chip 120 and in response to the received termination control command the chip 120 controls the cell-phone 200 to hang up.

In the invention, the user may also pick up a call received on the cell-phone 200 by detaching the headset 110 as shown in FIG. 2. The headset 110 comprises a headset holder 112 and an ear bud 114. The holder 112 is designed so that the user can easily place the headset 110 on his ear in a stable position. The ear bud 114 provides sound to the ear of the user. The design of the medallion 100 and the headset 110 as shown in FIG. 1 and FIG. 2 should not be considered as limiting the scope of the invention and alternative designs of the headset 110 are also within the scope of the invention. The headset 110 in normal position, i.e. when not is use, is mounted on the medallion 100 and rests on hooks 102 and 104. The headset 110 is detached when it is taken off the hooks 102 and 104 as shown in FIG. 2. As used herein, “detached” indicates that the headset 110 is not mounted on the medallion 100 any longer however the headset 110 may still be connected to the medallion 100 via a cord 106. The cord 106 conveys an audio signal to the ear bud 114. In another embodiment, the headset 110 can be disconnected from the medallion 100 in the sense that no data or power connection exists between the headset 110 and the medallion 100 when the headset 110 is detached from the device 100. In this other embodiment, the cord 106 may be a retractable string that prevents the user from losing the headset 110. In this case, the headset 110 is further built in with a Bluetooth module 170 to communicate with the medallion 100 when detached from it. Audio signals may then be transmitted from the medallion 100 to the ear bud 114 over a Bluetooth link between the Bluetooth modules 120 and 170.

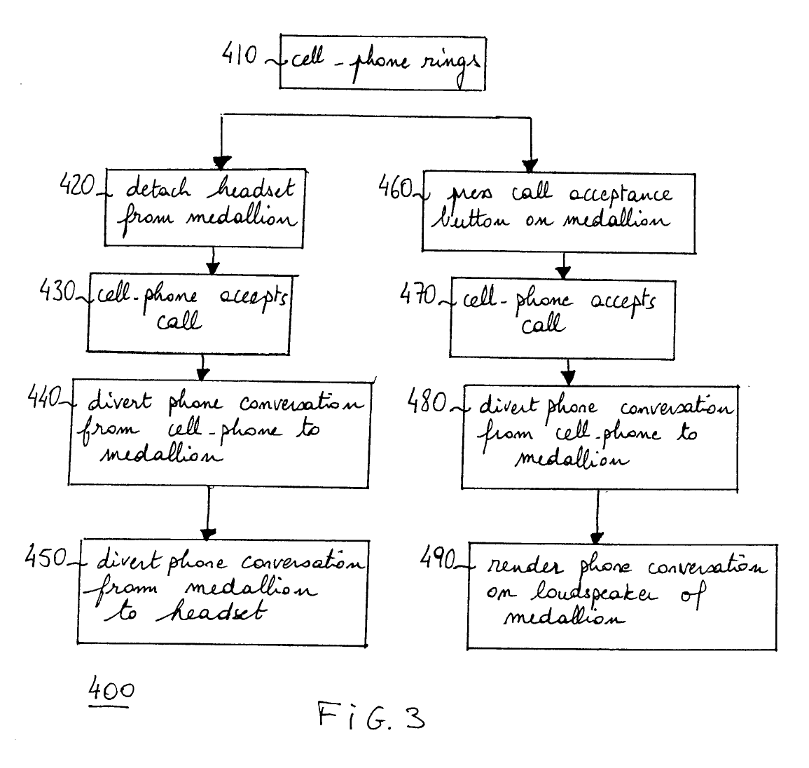

FIG. 3 is a flowchart 400 giving possible scenarios on how communications can be transferred from the cell-phone 200 to the medallion 100. When the phone rings in step 410, the user may accept an incoming call received by the cell-phone 200 over the network 300 using the medallion 100 by either detaching the headset 110 from the medallion 100 as explained above or by pressing the call acceptance button 160.

If the user chooses the alternative of the headset 110 in step 420, the medallion 100 detects that the user has detached the headset 110 from the medallion 100. A mechanical system may detect the absence of the headset 110 on the hooks 102 and 104. Other detection systems for detecting the detachment of the headset 110 are also within the scope of the invention. Upon detection, the Bluetooth module 120 transmits a Bluetooth control signal to the chip 210 to automatically configure the cell-phone 200 to accept the incoming call in step 430. As a result in step 440, the live voice data 10 associated with the call received over the wireless network 300 is diverted away from the cell-phone 200 to the medallion 100 and in step 450 the live voice data 10 is further diverted from the medallion 100 to the headset 110. The live voice data 10 is diverted in the following manner. A Bluetooth signal 20 is first generated and transmitted by the chip 210 to the module 120. The signal 20 is a low power signal representative of the live voice data 10 received by the cell-phone 200. The Bluetooth signal 20 may be then further transmitted from the module 120 to the module 170 for play out on the ear bud 114. The user may adjust the volume of the headset 110 with the volume control 130.

If the user accepts the call by pressing the button 160 in step 460, the module 470 configures the cell-phone 200 to accept the incoming call in step 470 as described in step 430. The live voice data 10 received over the wireless network 300 is then diverted in step 480 to the medallion 100 as described in step 440. In step 490, the medallion 100 is configured to render the live voice data 10 via a loudspeaker 180. The user may adjust the volume of the loudspeaker 180 with the volume control 130. It must be noted that the live voice data 10 is rendered via the loudspeaker 180 if the headset 110 is mounted on the medallion 100. If the headset 110 is then or was already detached from the medallion 100, the live voice data 10 is automatically forwarded from the medallion 100 to the headset 110 by the module 120.

When the live voice data 10 is rendered using either the loudspeaker 180 or the headset 110, the microphone 140 on the medallion 100 captures the user's voice. The module 120 transmits the user's voice to the cell-phone for transmission over the network 300. In another embodiment, the microphone 140 is placed on the headset 110 and the user's voice captured by the microphone 140 is transmitted from the headset 110 to the medallion 100 by the module 170 for further forwarding by the medallion 100 to the cell-phone 200.

The battery level indicator 150 informs the user of a status of an internal battery of the medallion 100. The battery of the device 100 provides the necessary power to the Bluetooth module 120 for it to communicate with the cell-phone 200 or any other Bluetooth device located in the receiving range of the Bluetooth module 120. The battery may be replaced when empty or the battery is possibly rechargeable thru a solar cell or by connection to a cigarette lighter power via an adaptor.

It must be appreciated that the automatic transfer of data other than voice data from the Bluetooth chip 210 to the Bluetooth module 120 when the headset 110 is detached is also encompassed in the invention. Indeed, the chip 210 may be configured to forward to the device 100 data representative of voice mails, songs, emails or the like. For example, when the cell-phone detects a new voice mail on the mailbox associated with the cell-phone 200, the cell-phone 200 audibly or visually notifies the user of the new voice mail. By detaching the headset 110 as mentioned above, the module 120 may configure the cell-phone 200 to automatically connect to the mailbox over the network 300 and retrieve the voice mail. The voice mail may then be forwarded to the headset 110 in the way mentioned above.

In yet another embodiment of the invention, the apparatus 200 may be a laptop with wireless connection to the network 300, e.g. a wireless modem. The module 120 may be configured to control the Bluetooth chip 210 to forward any data signal received by the apparatus 200 over the wireless network 300 when the headset 110 is detached from the medallion 100. For example, when the apparatus 200 receives a new email over the network 300, the chip 210 automatically forwards data representative of the email to the module 120 for rendering by the headset 110. The apparatus 200 may comprises a Text-to-Speech application that generates an audio file from the email and this audio file is forwarded by the chip 210 to the module 120 for further forwarding the module 170. In the invention, emails received by the apparatus 200 can then be automatically “read” to the user who had previously detached the headset 110 from the medallion 100. In anther embodiment, the user may have his emails played out loud by the speaker 180 when the headset 110 is mounted on the medallion 100. When the apparatus 200 notifies the user that a new email has been received, the user can press the button 160 to have an audio file representative of the email or the addresser played out on the loudspeaker 180.

1. A device comprising:
a Bluetooth module configured to receive a downlink wireless Bluetooth signal from a portable Bluetooth-enabled communication apparatus, the downlink wireless Bluetooth signal being representative of data received by the portable Bluetooth-enabled communication apparatus over a wireless network;
a control user interface, coupled to the Bluetooth module, enabling to transmit control commands to the portable Bluetooth-enabled communication apparatus via the Bluetooth module in response to respective user input commands; and,
a headset, detachably mounted on the device and operably coupled to the Bluetooth module, for automatically rendering an audio signal to the user based on the wireless Bluetooth signal when the headset is detached from the device.

2. The device of claim 1, further comprising:
a connector connecting the headset to the device and conveying the audio signal to the headset.

3. The device of claim 2, wherein the connector is retractable.

4. The device of claim 1, wherein the headset comprises a Bluetooth chip and the Bluetooth module is configured to automatically wirelessly forward the downlink wireless Bluetooth signal to the Bluetooth chip when the headset is physically disconnected from the device.

5. The device of claim 1, further comprising:
a speakerphone for audibly rendering the audio signal to the user upon command by the user when the headset is mounted on the device.

6. The device of claim 1, further comprising:
a microphone for converting a voice signal from the user into a low frequency voice signal; and
wherein the Bluetooth module is further configured to transmit to the portable Bluetooth-enable communication apparatus an uplink wireless Bluetooth signal based on the low frequency voice signal.

7. The device of claim 1, wherein the control user interface comprises a volume control enabling the user to adjust a volume of the headset to a desired level.

8. The device of claim 1, wherein the control user interface comprises a call control, which upon selection enables to configure the communication apparatus to accept a data communication initiated with the portable Bluetooth-enabled communication apparatus over the wireless network.

9. The device of claim 8, wherein the initiated data communication comprises a phone call.

10. The device of claim 8, wherein the initiated data communication comprises a transfer of an email.

11. The device of claim 1, wherein the control user interface comprises call control, which upon selection enables to configure the portable Bluetooth-enabled communication apparatus to interrupt a data communication initiated with the portable Bluetooth-enabled communication apparatus over the wireless network.

12. The device of claim 1, further comprising:
a rechargeable battery acting as a power source to the Bluetooth module.

13. The device of claim 12, wherein the battery comprises a light sensor for recharging the battery.

14. The device of claim 12, wherein the battery is rechargeable from a car cigarette lighter power source.
